(19) United States
(12) Patent Application Publication
(10) Pub. No.: US 2017/0017610 A1
(43) Pub. Date: Jan. 19, 2017

(54) METHOD AND APPARATUS FOR CONTROLLING RECONFIGURABLE PROCESSOR

(71) Applicant: SAMSUNG ELECTRONICS CO., LTD., Suwon-si (KR)

(72) Inventors: Dong-kwan SUH, Hwaseong-si (KR); Suk-jin KIM, Seoul (KR); Chul-soo PARK, Seoul (KR)

(73) Assignee: SAMSUNG ELECTRONICS CO., LTD., Suwon-si (KR)

(21) Appl. No.: 15/039,603

(22) PCT Filed: Nov. 28, 2014
(86) PCT No.: PCT/KR2014/011592

§ 371 Date: May 26, 2016

(30) Foreign Application Priority Data
Nov. 29, 2013 (KR) 10-2013-0147518

(51) Int. Cl. G06F 15/78; G06F 15/82

(52) U.S. Cl. CPC G06F 15/7871; G06F 15/82

(57) ABSTRACT

A technology for controlling a reconfigurable processor is provided. A determination is made as to whether configuration information is provided from a configuration buffer in a preset process performed by the reconfigurable processor, based on address values of the configuration information that are stored in the configuration buffer. Therefore, access to a configuration memory is controlled to reduce power consumption.

### TECHNICAL FIELD

One or more embodiments of the present invention relate to a method and apparatus for controlling a reconfigurable processor.

### BACKGROUND ART

A technology for a reconfigurable processor that simultaneously drives a plurality of operation units to perform operations has taken center stage. The reconfigurable processor operates in a coarse-grained array (CGA) mode to execute a loop related to a repetitive operation. An operation may be performed by several function units (FUs) in the CGA mode. In particular, an operation optimized for a particular job may be performed through a control of connection states between the FUs in the CGA mode.

A configuration memory of the reconfigurable processor stores parameter information for performing an operation through the FUs in the CGA mode and configuration information including information for connections between the FUs. The reconfigurable processor repetitively accesses the configuration memory to acquire the configuration information in order to perform an operation. If the reconfigurable processor repetitively accesses the configuration memory to perform the operation, power consumption increases.

### DISCLOSURE OF INVENTION

### Technical Problem

If the reconfigurable processor repetitively accesses the configuration memory to perform the operation, power consumption increases.

### Solution to Problem

One or more embodiments of the present invention include a method and apparatus for controlling an access to a configuration memory of a reconfigurable processor.

### Advantageous Effects of Invention

The reconfigurable processor control apparatus according to the present embodiment may reduce power consumption that may occur by accessing the configuration memory by the number of repetitions of the outer loop.

### BRIEF DESCRIPTION OF DRAWINGS

These and/or other aspects will become apparent and more readily appreciated from the following description of the embodiments, taken in conjunction with the accompanying drawings in which:

FIG. 1 is a block diagram of a system for controlling a reconfigurable processor, according to an embodiment of the present invention;

FIG. 2 is a view illustrating the reconfigurable processor according to an embodiment of the present invention;

FIG. 3 is a block diagram of a reconfigurable processor control apparatus according to an embodiment of the present invention;

FIG. 4 is a view illustrating a command configuring a nested loop according to an embodiment of the present invention;

FIG. 5 is a flowchart of a method of controlling a reconfigurable processor, according to an embodiment of the present invention; and

FIG. 6 is a flowchart of a method of determining whether configuration information is provided from a configuration buffer based on address values of the configuration information, according to an embodiment of the present invention.

### BEST MODE FOR CARRYING OUT THE INVENTION

One or more embodiments of the present invention include a method and apparatus for controlling an access to a configuration memory of a reconfigurable processor.

Additional aspects will be set forth in part in the description which follows and, in part, will be apparent from the description, or may be learned by practice of the presented embodiments.

According to one or more embodiments of the present invention, a method to control a reconfigurable processor, the method comprising: acquiring address values of configuration information for performing a first process that are stored in a configuration buffer of the reconfigurable processor; determining whether the configuration information is provided from the configuration buffer in a second process, based on the address values of the configuration information; and providing the determination result to the reconfigurable processor.

The determining of whether the configuration information is provided from the configuration buffer comprises: acquiring address values of configuration information for performing the second process; comparing the address values of the configuration information for performing the first process with the address values of the configuration information for performing the second process; and determining whether the configuration information is provided from the configuration buffer in the second processor, based on the comparison result.

If the address values of the configuration information for performing the first process match with the address values of the configuration information for performing the second process, the configuration information is determined as being provided from the configuration buffer in the second process.

The providing of the determination result to the reconfigurable processor comprises: if it is determined that the configuration information is provided from the configuration buffer in the second process, transmitting a control signal indicating that the configuration information is provided from the configuration buffer, to the reconfigurable processor.

The configuration information for performing the first process is stored in the configuration buffer to have adjacent address values.

Commands constituting the first and second processes are the same.

According to one or more embodiments of the present invention, an apparatus for controlling a reconfigurable processor, the apparatus comprising: an input unit which acquires address values of configuration information for performing a first process that are stored in a configuration buffer of the reconfigurable processor; a controller which determines whether the configuration information is provided from the configuration buffer in a second process, based on the address values of the configuration information; and an output unit which provides the determination result to the reconfigurable processor.

The controller compares the address values of the configuration information for performing the first process with address values of configuration information for performing the second process and determines whether the configuration information for performing the second process is provided from the configuration buffer, based on the comparison result.

If the address values of the configuration information for performing the first process match with the address values of the configuration information for performing the second process according to the comparison result, the controller determines that the configuration information is provided from the configuration buffer in the second process.

If it is determined that the configuration information is provided from the configuration buffer in the second process, the output unit transmits a control signal indicating that the configuration information is provided from the configuration information, to the reconfigurable processor.

The configuration information for performing the first process is stored in the configuration buffer to have adjacent address values.

Commands constituting the first and second processes are the same.

According to one or more embodiments of the disclosure, a non-transitory computer readable recording medium may have recorded thereon one or more programs for executing any of the methods disclosed herein.

### MODE FOR THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element, such as a layer, a region, or a substrate, is referred to as being “on,” “connected to” or “coupled to” another element, it may be directly on, electrically connected or coupled to the other element or intervening elements may be present. In contrast, when an element is referred to as being “directly on,” “directly connected to” or “directly coupled to” another element or layer, there are no intervening elements or layers present. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The present invention will now be described in detail with reference to the attached drawings.

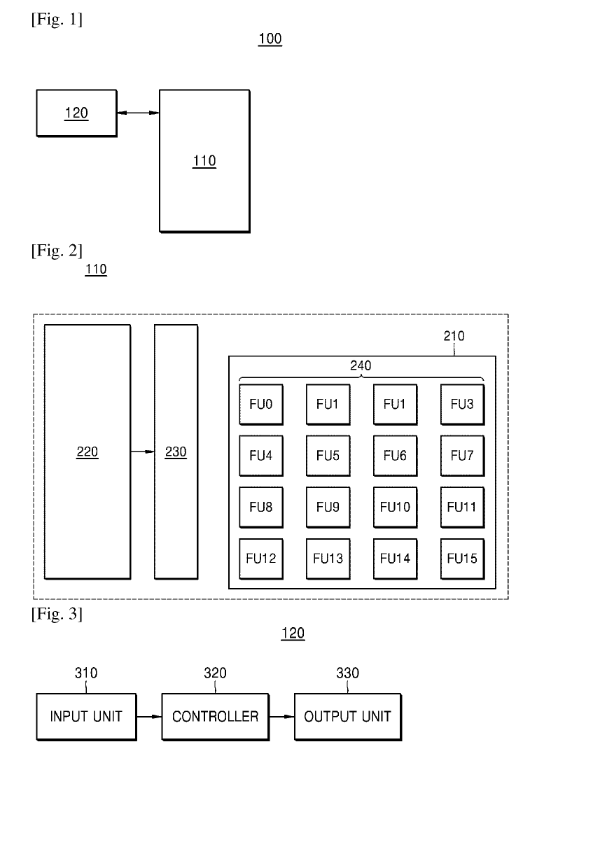

FIG. 1 is a view illustrating a system 100 for controlling a reconfigurable processor 110, according to an embodiment of the present invention.

Referring to FIG. 1, the system 100 includes the reconfigurable processor 110 and a reconfigurable processor control apparatus 120.

The system 100 of FIG. 1 includes only elements related to the present embodiment. Therefore, the system 100 may further include other types of general-purpose elements besides the elements of FIG. 1.

The reconfigurable processor 110 may include a coarse-grained array (CGA) mode having a reconfiguration array so as to simultaneously execute a plurality of applications. In the CGA mode, the reconfiguration array may be formed of a combination of resources including a plurality of function units (FUs), a register file, an interconnection node, a constant node, etc.

The reconfigurable processor 110 may control a reconfiguration array based on configuration information stored in a configuration memory. Here, the configuration information may include instruction information allocated to each of the FUs configuring the reconfiguration array and connection information between the FUs.

The configuration information may be demanded in each cycle in which the CGA mode is performed, to control the reconfiguration array. Since a loop is mapped on the reconfiguration array, the same configuration information is used whenever the CGA mode is performed. If the reconfiguration array accesses the configuration memory in each cycle to acquire the configuration information in the CGA mode, power consumption may increase.

A configuration buffer having a smaller number of entries than the configuration memory may be used as a method of reducing power consumption due to access to the configuration memory. If the loop is mapped on the reconfiguration array, the reconfigurable processor 110 may separately store and use repetitive configuration information by using a characteristic in which the same configuration information is repeated. If the configuration buffer is used, the number of accesses to the configuration memory that is relatively larger than the configuration buffer is reduced, and thus the power consumption used for performing the CGA mode may be reduced.

The reconfigurable processor control apparatus 120 according to the present embodiment may control access to the configuration memory of the reconfiguration array. In detail, the reconfigurable processor control apparatus 120 may provide the reconfigurable processor 110 with information about whether the configuration information used when performing the CGA mode is stored in the configuration buffer. For example, if the configuration information used when performing the CGA mode is stored in the configuration buffer, the reconfigurable processor control apparatus 120 may provide the reconfiguration array with the information that the configuration information is stored in the configuration buffer. The reconfiguration array may acquire the configuration information from the configuration buffer based on the information provided by the reconfigurable processor control apparatus 120.

For example, the reconfiguration array will be mapped on a nested loop. The nested loop includes an outer loop and an inner loop. The reconfigurable processor control apparatus 120 may provide the reconfiguration array with information about whether configuration information for performing the outer and inner loops is stored in the configuration buffer.

If the configuration information for performing the outer loop is stored in the configuration buffer, the reconfigurable processor control apparatus 120 may provide the reconfiguration array with information that the configuration information is acquired from the configuration buffer. Therefore, the reconfiguration array may acquire the configuration information from the configuration buffer by the number of repetitions of the outer loop. The reconfigurable processor control apparatus 120 according to the present embodiment may reduce power consumption that may occur by accessing the configuration memory by the number of repetitions of the outer loop.

FIG. 2 is a view illustrating the reconfigurable processor 110 according to an embodiment of the present invention.

Referring to FIG. 2, the reconfigurable processor 110 includes a reconfiguration array 210, a configuration memory 220, and a configuration buffer 230.

The reconfiguration array 210 may include a plurality of FUs. The FUs may independently process tasks or instructions. For example, the reconfiguration array 210 may process a preset job in parallel by using the plurality of FUs that independently operate. The FUs may include processing elements that perform arithmetical and logical operations and register files that temporarily store operation results.

The configuration memory 220 stores configuration information of the reconfiguration array 210. The configuration information may define instruction information allocated to each of the FUs and connection states between the plurality of FUs. Therefore, instructions respectively mapped on the FUs and the connection states between the plurality of FUs may vary according to the configuration information stored in the configuration memory 220.

For example, if a program counter (not shown) indicates first configuration information, instruction A may be mapped on FU0, and an output of the FU0 may be connected to an input of FU4 according to the first configuration information. Also, if the program counter indicates second configuration information, instruction B may be mapped on the FU0, and the output of the FU0 may be connected to an input of FU5 according to the second configuration information. In other words, the reconfigurable processor 110 may control a configuration of the reconfiguration array 210 to be optimized for a particular job according to configuration information indicated by a value of the program counter.

The configuration buffer 230 may store configuration information of a loop that is repetitively performed. The configuration buffer 230 consumes relatively smaller power than the configuration memory 220 due to access to the reconfiguration array 210. Therefore, if a loop operation that has a large number of operations due to repetitions is mapped on the FUs of the reconfiguration array 210, the reconfiguration array 210 may access the configuration buffer 230 to acquire configuration information in order to reduce power consumption.

The reconfigurable processor control apparatus 120 of FIG. 1 according to the present embodiment may provide the reconfiguration array 210 with information about a storage position of configuration information for performing a CGA mode. If the configuration information is stored in the configuration buffer 230, the reconfiguration array 210 receives information that the configuration information is stored in the configuration buffer 230, from the reconfigurable processor control apparatus 120 to reduce the number of accesses to the configuration memory 220 in order to reduce power consumption.

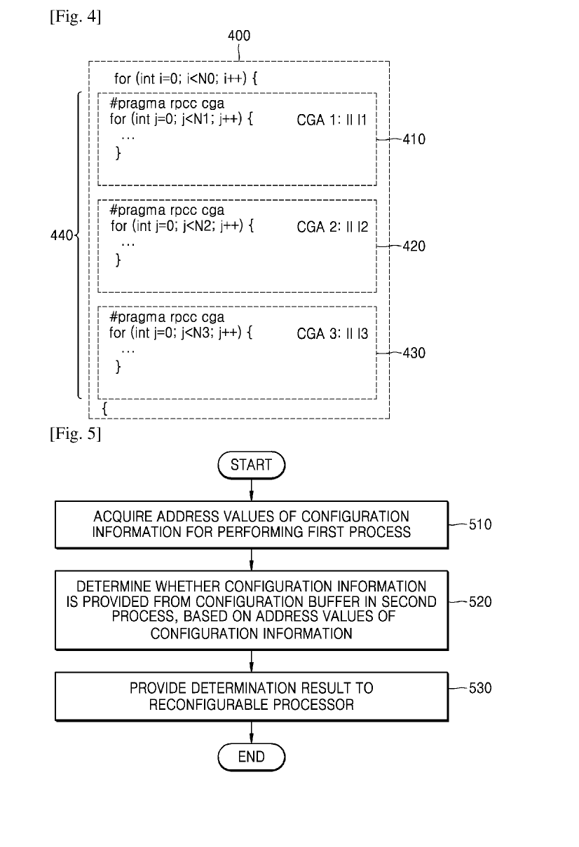

FIG. 3 is a block diagram of the reconfigurable processor control apparatus 120 according to an embodiment of the present invention.

Referring to FIG. 3, the reconfigurable processor control apparatus 120 includes an input unit 310, a controller 320, and an output unit 330.

The reconfigurable processor control apparatus 120 of FIG. 3 includes only elements related to the present embodiment. Therefore, the reconfigurable processor control apparatus 120 may further include other types of general-purpose elements besides the elements of FIG. 3.

If the reconfigurable processor control apparatus 120 according to the present embodiment performs processes in a CGA mode, the reconfigurable processor control apparatus 120 may control access to the configuration memory 220 of the reconfiguration array 210 of the reconfigurable processor 110.

When an operation that commands a very long instruction word (VLIW) mode to be changed into the CGA mode is performed, the reconfigurable processor 110 starts to change the VLIV mode into the CGA mode in order to perform preset processes in the CGA mode. The operation that commands the VLIW mode to be changed into the CGA mode may include start position information that configuration information for performing the processes is stored in the configuration memory 220 and size information about how many entries are read based on the start position information.

The reconfigurable processor 110 may repetitively read the configuration information by the number of entries starting from a start position of the configuration memory 220 to operate based on the start position information and the size information.

The input unit 310 may acquire address values of the configuration information for performing a first process. According to an embodiment of the present invention, the reconfiguration array 210 may acquire the configuration information for performing the first process in the FUs from the configuration memory 220. The acquired configuration information may be stored in the configuration buffer 230. Here, the input unit 310 may acquire position information of the configuration memory 220 in which the configuration information for performing the first process is stored. For example, the input unit 310 may acquire the start position information and the size information of the configuration memory 220 in which the configuration information for performing the first process is stored.

According to an embodiment of the present invention, the first process may include at least one or more inner loops. The reconfiguration array 210 may acquire the configuration information for performing the at least one or more inner loops included in the first process from the configuration memory 220 and store the configuration information in the configuration buffer 230.

The configuration information may have address values respectively corresponding to the configuration information and be stored in the configuration buffer 230. If a program counter (not shown) indicates a preset address value, operations of the FUs according to configuration information corresponding to the preset address value may be performed.

The input unit 310 may acquire position information of the configuration memory 220 in which configuration information for performing a second process is stored. Here, the position information of the configuration memory 220 in which the configuration information for performing the second process is stored may include address values of the configuration information for performing the second process, wherein the configuration information is stored in the configuration memory 220. The controller 320 may determine whether the configuration information is provided from the configuration buffer 230 in the second process. Here, commands constituting the first and second processes may be the same.

The controller 320 may compare the address values of the configuration information that are acquired in the first process with the address values of the configuration information that are acquired in the second process.

The controller 320 may also determine whether the configuration information for performing the second process is provided from the configuration buffer 230. If the address values of the configuration information for performing the first process match with the address values of the configuration information for performing the second process according to the comparison result, the controller 320 may determine that the configuration information is provided from the configuration buffer 230 in the second process.

The configuration information may be stored in positions of adjacent addresses in the configuration buffer 230. However, this is only an embodiment, and the present invention is not limited thereto.

The output unit 330 may transmit a control signal indicating whether the configuration buffer 230 provides the configuration information to the reconfiguration array 210, to the reconfigurable processor 110. In detail, if it is determined that the configuration information is provided from the configuration buffer 230 in the second process, the configuration buffer 230 may transmit the control signal indicating that the configuration buffer 230 provides the configuration information to the reconfiguration array 210, to the reconfigurable processor 110.

FIG. 4 is a view illustrating a command constituting a nested loop 400 according to an embodiment of the present invention.

Referring to FIG. 4, the nested loop 400 includes a first inner loop 410, a second inner loop 420, a third inner loop 430, and an outer loop 440.

The first inner loop 410 according to the present embodiment may have N1 number of loop repetitions. An initial interval (II) of the first inner loop 410 may be assumed as I1. The second inner loop 420 may have N2 number of loop repetitions. An I2 of the second inner loop 420 may be assumed as 7. The third inner loop 430 may have N3 number of loop repetitions. An II of the third inner loop 430 may be assumed as I3. The outer loop 440 may have N0 number of loop repetitions. An II of the outer loop 440 may be assumed as I1+I2+I3, where the IIs of the first, second, and third inner loops 410, 420, and 430 are summed.

In the nested loop 400 according to the present embodiment, a first process includes a process that is performed one time among processes that are performed N0 times in the outer loop 440. A second process may include another process that is performed one time among the processes that are performed N0 times in the outer loop 440.

If the nested loop 400 is performed in the reconfiguration array 210, the reconfigurable processor control apparatus 120 may acquire address values stored in the configuration buffer 230 in the first process. The reconfigurable processor control apparatus 120 may determine whether configuration information is provided from the configuration buffer 230 in the second process, based on the address values of the configuration information.

The reconfigurable processor control apparatus 120 may check address values of configuration information acquired in each process based on a history of address values stored in a buffer (not shown). The reconfigurable processor control apparatus 120 may compare address values of the configuration information that are acquired in the first process with address values of configuration information that are acquired in the second process.

The reconfigurable processor control apparatus 120 may determine whether the configuration information is provided from the configuration buffer 230 in the second process, based on the comparison result. If the address values of the configuration information that are acquired in the first process match with the address values of the configuration information that are acquired in the second process according to the comparison result, the reconfigurable processor control apparatus 120 may determine that the configuration information is provided from the configuration buffer 230 in the second process.

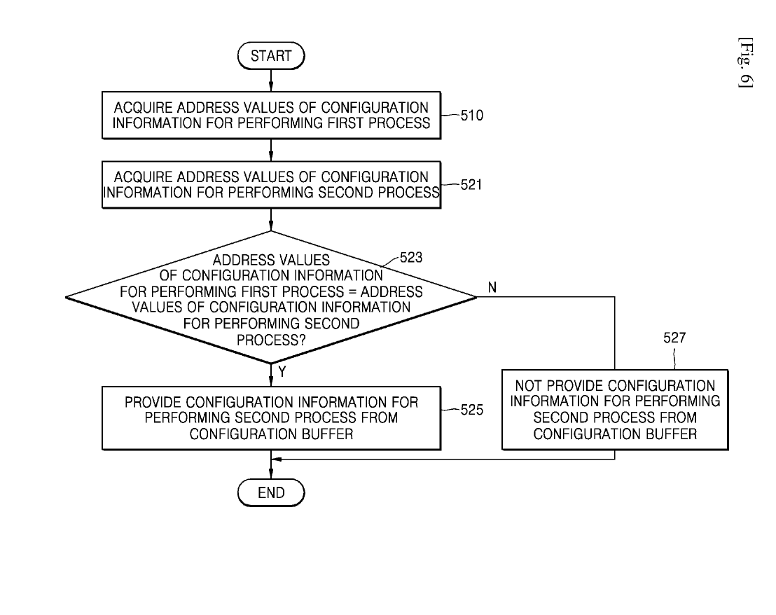

FIG. 5 is a flowchart of a method of controlling a reconfigurable processor, according to an embodiment of the present invention.

In operation 510, the reconfigurable processor control apparatus 120 acquires address values of configuration information for performing a first process through the reconfigurable processor 110. Here, the reconfigurable processor 110 may include the reconfiguration array 210, the configuration memory 220, and the configuration buffer 230.

Here, the address values may be position information indicating that the configuration information for performing the first process is stored in the configuration memory 220. For example, the position information may include start position information and size information indicating that the configuration information is stored in the configuration memory 220.

According to an embodiment of the present invention, the reconfigurable processor control apparatus 120 may control the number of accesses to the configuration memory 220 of the reconfiguration array 210.

According to an embodiment of the present invention, the reconfiguration array 210 may acquire the configuration information for performing the first process from the configuration memory 220. The acquired configuration information may be stored in the configuration buffer 230.

In operation 520, the reconfigurable processor control apparatus 120 determines whether configuration information is provided from the configuration buffer 230 in the second process, based on the address values of the configuration information that are acquired in operation 510. Here, commands constituting the first and second processes may be the same.

According to an embodiment of the present invention, the reconfigurable processor control apparatus 120 may read one of the repetitive address values of the configuration information based on a history of the acquired address values.

The reconfigurable processor 110 according to the present embodiment may acquire address values of configuration information stored in the configuration buffer 230 in the second process. If the address values of the configuration information for performing the first process match with the address values of the configuration information for performing the second process, the reconfigurable processor 110 may determine that the configuration information for performing the second process is provided from the configuration buffer 230.

In operation 530, the reconfigurable processor control apparatus 120 provides the determination result of operation 520 to the reconfigurable processor 110. If it is determined that the configuration information is provided from the configuration buffer 230 in the second process, the reconfigurable processor control apparatus 120 may transmit a control signal indicating that the configuration buffer 230 provides the configuration information in the second process, to the reconfigurable processor 110.

FIG. 6 is a flowchart of a method of determining whether configuration information is provided based on address values of the configuration information, according to an embodiment of the present invention.

In operation 510, the reconfigurable processor control apparatus 120 acquires address values of configuration information for performing a first process through the reconfigurable processor 110. Here, the reconfigurable processor 110 may include the reconfiguration array 210, the configuration memory 220, and the configuration buffer 230.

Here, the address values may be position information indicating that the configuration information for performing the first process is stored in the configuration buffer 220. For example, the position information may include start position information and size information indicating that the configuration information is stored in the configuration memory 220.

In operation 521, the reconfigurable processor control apparatus 120 acquires address values of configuration information for performing a second process through the reconfigurable processor 110.

In operation 523, the reconfigurable processor control apparatus 120 compares the address values of the configuration information for performing the second process with the address values of the configuration information for performing the first process based on a read address value. If the address values of the configuration information for performing the first process match with the address values of the configuration information for performing the second process according to the comparison result, the reconfigurable processor control apparatus 120 may determine that the configuration information for performing the second process is provided from the configuration buffer 230.

In operation 525, the reconfigurable processor control apparatus 120 acquires the configuration information for performing the second process from the configuration buffer 230. In this case, the reconfigurable processor control apparatus 120 may determine that the configuration information for performing the second process is provided from the configuration buffer 230.

In operation 527, the reconfigurable processor control apparatus 120 does not acquire the configuration information for performing the second process from the configuration buffer 230. In this case, the reconfigurable processor control apparatus 120 may control the reconfigurable processor 110 to acquire the configuration information for performing the second process from the configuration memory 220.

An apparatus according to the present invention may include a processor, a memory that stores and executes program data, a permanent storage such as a disk drive, a communication port that communicates with an external apparatus, a user interface such as a touch panel, a key pad, buttons, or the like, etc. Methods of embodying a software module or an algorithm may be stored as computer-readable code or program commands executable on the processor, on a computer-readable recording medium. Examples of the computer-readable recording medium include a magnetic storage medium (for example, read-only memory (ROM), random-access memory (RAM), a floppy disc, a hard disk, etc.) and an optical reading medium (for example, CD-ROMs, digital versatile discs (DVDs), etc.). The computer-readable recording medium may also be distributed over network-coupled computer systems so that the computer-readable code is stored and executed in a distributed fashion. The computer-readable recording medium may be read by a computer, stored in a memory, and executed by a processor.

All types of documents, including published documents, patent applications, patents, etc. cited in the present invention may be incorporated herein in their entirety by reference.

For understanding the present invention, reference numerals are shown in the embodiments illustrated in the drawings, and particular terminologies are used to describe the embodiments. However, the present invention is not limited by the particular terminologies, and the present invention may include all types of elements that may be considered by those of ordinary skill in the art.

The present invention may be embodied as functional block structures and various processing operations. These functional blocks may be embodied via various numbers of hardware and/or software structures that execute particular functions. For example, the present invention may use direct circuit structures, such as a memory, processing, logic, a look-up table, etc. that may execute various functions through controls of one or more microprocessors or other control apparatuses. Like elements of the present invention may be executed as software programming or software elements, the present invention may be embodied as a programming or scripting language such as C, C++, assembly language, or the like, including various algorithms that are realized through combinations of data structures, processes, routines, or other programming structures. Functional sides may be embodied as an algorithm that is executed by one or more processors. Also, the present invention may use related arts to perform electronic environment setting, signal processing, and/or data processing, etc. Terminology such as a mechanism, an element, a means, or a structure may be widely used and is not limited as mechanical and physical structures. The terminology may also include meanings of a series of routines of software along with a processor, etc.

The embodiments described in the present invention are just exemplary and do not limit the scope of the present invention. For conciseness of the present specification, descriptions of the conventional electronic elements, control systems, software, and other functional sides of the systems have been omitted. Also, connections between lines of elements shown in the drawings or connection members of the lines exemplarily indicate functional connections and/or physical connections or circuit connections. The connections may be replaced or may be indicated as additional various functional connections, physical connections, or circuit connections in a real apparatus. If there is no detailed mention such as “necessary”, “important”, or the like, the connections may not be elements for making the present invention.

The uses of the term “the” and an indicating term similar to the term “the” in the specification of the present invention (in particular, in claims) may correspond to both the singular number and the plural number. If a range is described in the present invention, individual values belonging to the range are applied to the present invention (if there is no description in contrast to this), i.e., the individual values constituting the range are like being described in the detailed description of the present invention. If an order of operations constituting a method according to the present invention is clearly described or there is no description in contrast to the order, the operations may be performed in any appropriate order. The present invention is not necessarily limited to the description order of the operations. The users of all examples or exemplary terms (for example, “etc.”) in the present invention are simply for describing the present invention. Therefore, as the scope of the present invention is not limited by the following claims, it is not limited by the examples or the exemplary terms. It will be understood by those of ordinary skill in the art that various modifications, combinations, and changes in form and details may be made according to design conditions and factors therein without departing from the spirit and scope of the present invention as defined by the following claims or equivalents thereof.

1. A method of controlling a reconfigurable processor, the method comprising:
acquiring address values of configuration information for performing a first process that are stored in a configuration buffer of the reconfigurable processor;
determining whether the configuration information is provided from the configuration buffer in a second process, based on the address values of the configuration information; and
providing the determination result to the reconfigurable processor.

2. The method of claim 1, wherein the determining of whether the configuration information is provided from the configuration buffer comprises:
acquiring address values of configuration information for performing the second process;
comparing the address values of the configuration information for performing the first process with the address values of the configuration information for performing the second process; and
determining whether the configuration information is provided from the configuration buffer in the second processor, based on the comparison result.

3. The method of claim 2, wherein if the address values of the configuration information for performing the first process match with the address values of the configuration information for performing the second process, the configuration information is determined as being provided from the configuration buffer in the second process.

4. The method of claim 1, wherein the providing of the determination result to the reconfigurable processor comprises: if it is determined that the configuration information is provided from the configuration buffer in the second process, transmitting a control signal indicating that the configuration information is provided from the configuration buffer, to the reconfigurable processor.

5. The method of claim 1, wherein the configuration information for performing the first process is stored in the configuration buffer to have adjacent address values.

6. The method of claim 1, wherein commands constituting the first and second processes are the same.

7. An apparatus for controlling a reconfigurable processor, the apparatus comprising:
an input unit which acquires address values of configuration information for performing a first process that are stored in a configuration buffer of the reconfigurable processor;
a controller which determines whether the configuration information is provided from the configuration buffer in a second process, based on the address values of the configuration information; and
an output unit which provides the determination result to the reconfigurable processor.

8. The apparatus of claim 7, wherein the controller compares the address values of the configuration information for performing the first process with address values of configuration information for performing the second process and determines whether the configuration information for performing the second process is provided from the configuration buffer, based on the comparison result.

9. The apparatus of claim 8, wherein if the address values of the configuration information for performing the first process match with the address values of the configuration information for performing the second process according to the comparison result, the controller determines that the configuration information is provided from the configuration buffer in the second process.

10. The apparatus of claim 7, wherein if it is determined that the configuration information is provided from the configuration buffer in the second process, the output unit transmits a control signal indicating that the configuration information is provided from the configuration information, to the reconfigurable processor.

11. The apparatus of claim 7, wherein the configuration information for performing the first process is stored in the configuration buffer to have adjacent address values.

12. The apparatus of claim 8, wherein commands constituting the first and second processes are the same.

13. A computer-readable recording medium having recorded thereon a program for executing the method of claim 1.
